(19) United States
(12) Patent Application Publication
(10) Pub. No.: US 2008/0092609 A1
(43) Pub. Date: Apr. 24, 2008

(54) Aircraft Locking System

(76) Inventor: Dani Markbreit, Azur (IL)

Correspondence Address: DEKEL PATENT LTD., DAVID KLEIN, BEIT HAROF'IM, 18 MENUHA VENAHALA STREET, ROOM 27, REHOVOT, 76209, IL

(21) Appl. No.: 11/815,450

(22) PCT Filed: Feb. 19, 2006
(86) PCT No.: PCT/IL06/00211

§ 371 Date: Aug. 3, 2007

(30) Foreign Application Priority Data
Feb. 23, 2005 (IL) 167070

(51) Int. Cl. E05B 65/12

(52) U.S. Cl. 70/254

(57) ABSTRACT

An aircraft locking system (10) is described that includes an electromechanical lock that has a shackle (14) actuable by the lock, the shackle being adapted to lock a flight control system. The electromechanical lock may include data encryption electronics.

### FIELD OF THE INVENTION

The present invention relates generally to locking systems, and particularly to a locking system for locking aircraft accessories, such as but not limited to, a flight control system.

### BACKGROUND OF THE INVENTION

Small, propeller driven and jet aircraft are often parked and left unattended outside in a remote area of a large airport, or outside at smaller, local airports, and in both cases there is very little traffic in the way of individuals in the area. Moreover, there generally is little or no provision of security personnel to watch unattended aircraft, and even if an owner normally parks his or her aircraft in a hanger, there are instances where the aircraft is temporarily parked outside and left unattended, or towed or taxied from the hanger to a maintenance area in which the aircraft is left unattended pending the inspection, performance of maintenance or the like. Further, hangers are often left open, and in all of the foregoing situations the aircraft is subject to unauthorized use or operation as well as theft, especially at smaller airports where there is minimal air traffic and security and thus more than ample opportunity to steal or take a joy ride in the aircraft.

Some smaller aircraft have key operated ignition systems in which the wires can be readily crossed if necessary to enable operation of the engine of the aircraft. However, in connection with such small aircraft, owners often leave the key in place, especially when the aircraft has been parked in a maintenance area, whereby the crossing of wires is not necessary to operate the aircraft. Still further, some owners replace the key switch with a toggle switch for convenience, and many aircraft as manufactured do not have a key operated switch and are operable merely by actuating a toggle switch. While small aircraft parked outside are often tethered to the ground, such tethering is primarily for the purpose of maintaining the aircraft in place during high winds and is neither intended to nor capable of deterring theft or unauthorized operation of the aircraft. In this respect, such tethering arrangements generally include rope or other lines which are tied in place or which are provided with mechanical clasps or the like, whereby the lines are readily cut or detached from the aircraft.

U.S. Pat. No. 6,212,920 to Winner describes an anti-theft device for an aircraft, which includes first and second U-shaped members one of which has tubular legs telescopically receiving arms of the other and one of the arms of which extends through a passage in sleeve and control post components in the cockpit of an aircraft to lock the aileron and elevator components of the aircraft against displacement relative to the aircraft wings and stabilizer, respectively. A key or combination type lock releasably holds the anti-theft device in its mounted condition.

U.S. Pat. No. 6,393,880 to Vance, Sr. describes an aircraft anti-theft device for immobilizing the yoke of an aircraft. The aircraft anti-theft device includes a device for immobilizing the yoke control of an aircraft. The yoke control has a gust lock hole for holding the yoke in a stationary position. The device has a sleeve for wrapping about the yoke control. The sleeve has an interior channel for receiving a portion of the yoke control. The sleeve is divided along its longitudinal axis to form first and second sections. A pin for insertion into the gust lock is fixedly coupled to an interior surface of the first section of the sleeve. The first and second sections are placed around the yoke control such that the pin enters the gust lock. A lock locks the first and second sections in a closed position.

### SUMMARY OF THE INVENTION

The present invention seeks to provide an improved aircraft locking system, as described more in detail hereinbelow. The aircraft locking system may be used to lock many lockable components of the aircraft and contrary to the prior art is not limited to locking just one component.

There is thus provided in accordance with an embodiment of the present invention an aircraft and aircraft locking system (e.g., adapted to lock the flight control system of the aircraft), the aircraft locking system including an electromechanical lock that includes a shackle actuable by the lock, the shackle being adapted to lock a flight control system.

The electromechanical lock may include data encryption electronics.

The electromechanical lock may include a warning label having a mounting hole through which the shackle passes, the warning label having an indication formed thereon that warns that the shackle must be removed before performing a flight-related action with the aircraft.

Further in accordance with an embodiment of the present invention the electromechanical lock may include a padlock body. The electromechanical lock may include an anti-tampering electronic tag adapted to provide an output indication of an attempt to tamper with the aircraft locking system.

In one non-limiting embodiment, the shackle may pass through and lock a gust lock hole on the flight control system. Alternatively, the shackle may pass through and lock a flexible locking member and a yoke member, at least one of the flexible locking member and the yoke member passing through a gust lock hole on the flight control system. As another alternative, the shackle may pass through and lock sleeve locking elements that fit on the flight control system.

### BRIEF DESCRIPTION OF THE DRAWINGS

The present invention will be understood and appreciated more fully from the following detailed description taken in conjunction with the drawings in which:

FIG. 1 is a simplified pictorial illustration of an aircraft locking system, constructed and operative in accordance with an embodiment of the present invention, shown with the shackle locking a gust lock hole on a control stick;

FIG. 2 is a simplified pictorial illustration of the aircraft locking system of FIG. 1, shown with a flexible locking member locking the gust lock hole on the flight control system;

FIG. 3 is a simplified pictorial illustration of the aircraft locking system of FIG. 1, shown locking sleeve locking elements; and

FIG. 4 is a simplified pictorial illustration of the aircraft locking system of FIG. 1, shown with locking sleeve locking elements locking a floor-mounted flight control system.

### DETAILED DESCRIPTION OF EMBODIMENTS

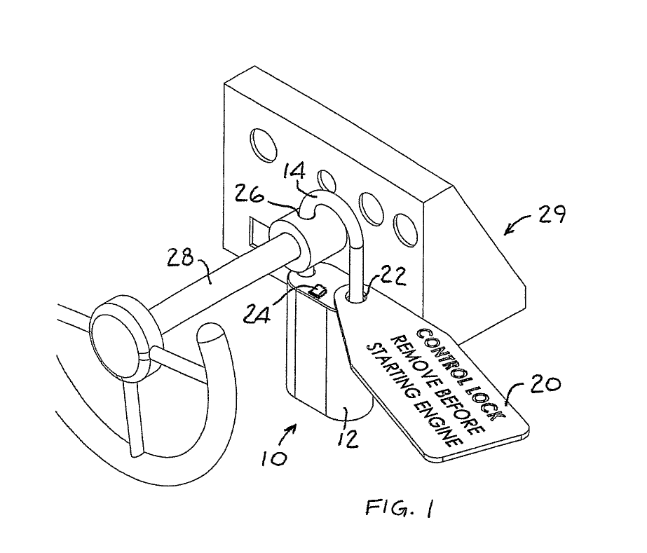

Reference is now made to FIG. 1, which illustrates an aircraft locking system 10, constructed and operative in accordance with an embodiment of the present invention.

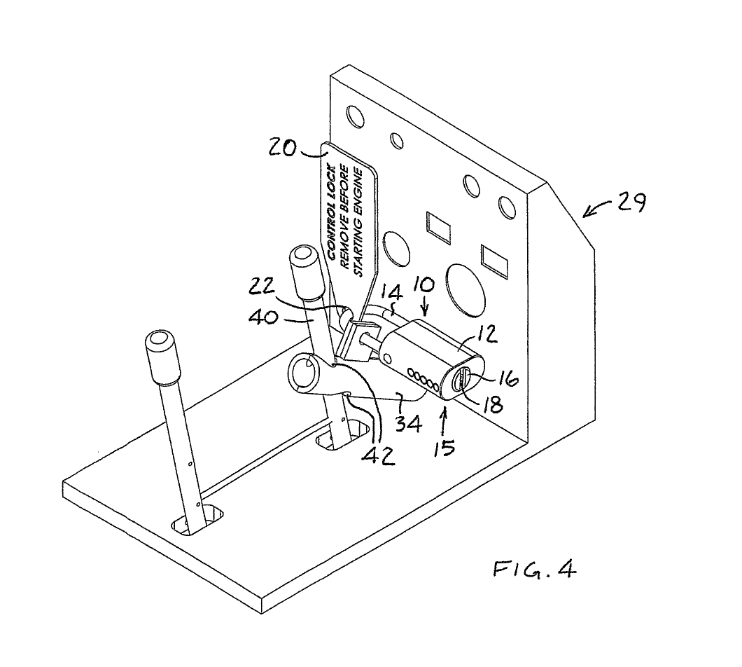

The aircraft locking system 10 may include a padlock body 12 and shackle 14, constructed of any suitable material, such as but not limited to, hardened steel alloy. Shackle 14 is shown as U-shaped with legs of any length, but the invention is not limited to this shape and also encompasses other shapes, such as but not limited to, straight or curved pins. The aircraft locking system 10 may include a lock 15 (seen in FIG. 4) disposed in padlock body 12, such as but not limited to, a cylinder lock with a rotatable plug 16 (seen in FIG. 4). As is well known in the art, plug 16 is rotatable upon insertion into a keyway 18 (seen in FIG. 4) thereof by a proper key (not shown).

In accordance with an embodiment of the invention, aircraft locking system 10 may comprise an electromechanical lock, such as but not limited to, the Interactive Cliq E-Series Padlock, commercially available from Mul-T-Lock Ltd. This is an intelligent, flexible and customizable lock that integrates ASSA ABLOY'S patented CLIQ technology, based on miniaturized data encryption electronics that can be embedded directly inside the key and core of the cylinder lock. The Interactive CLIQ key contains a unique electronic identification code, designated for one individual only, which cannot be duplicated, altered or corrupted. A replaceable, long-life battery is also inserted into the key and serves as the sole power source for the entire key and cylinder system.

Aircraft locking system 10 may include a warning label 20 (alternatively referred to as a tag or flag and the like), which may have a mounting hole 22 through which shackle 14 passes. Warning label 20 may have a warning or other indication printed, embossed, engraved or otherwise formed thereon, which warns that shackle 14 (or any other portion of aircraft locking system 10) must be removed before performing a flight-related action, e.g., before starting the engine. Warning label 20 may be flexible or rigid, and may be made of plastic, leather, wood, metal or other materials and combinations thereof.

In accordance with an embodiment of the present invention, aircraft locking system 10 may include an electronic tag 24, such as but not limited to, the electronic tag described in U.S. Pat. No. 6,255,958 to Haimovich et al. Electronic tag 24 (shown for simplicity only in FIG. 1) may serve as an anti-tampering and/or anti-theft tag assembly, which may provide an output indication of an attempt to tamper with aircraft locking system 10. Electronic tag 24 may transmit the output indication (e.g., by cellular communication, infrared, BLUETOOTH, RF, satellite, Internet or any other communication means) to a local or remote base station, server, controller or some authority, for example (not shown). Electronic tag 24 may be attached to or disposed in padlock body 12 by any suitable means (e.g., bonding, soldering, fasteners, etc.).

In FIG. 1, the aircraft locking system 10 is shown with shackle 14 passing through and locking a gust lock hole 26 on a flight control system 28 of an aircraft 29 (partially shown).

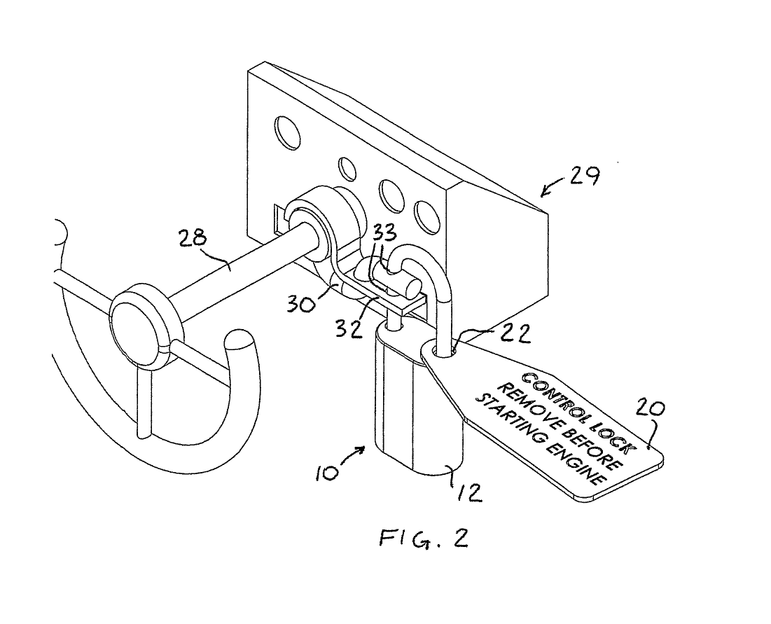

In FIG. 2, the aircraft locking system 10 is shown with shackle 14 passing through and locking a flexible locking member 30 locking the gust lock hole 26 on flight control system 28. The flexible locking member 30 may include a flexible wire, chain or other elongate member that is locked by shackle 14 to a yoke member 32. Either or both of flexible locking member 30 and yoke member 32 may pass through gust lock hole 26. Shackle 14 may pass through holes 33 formed in flexible locking member 30 and yoke member 32.

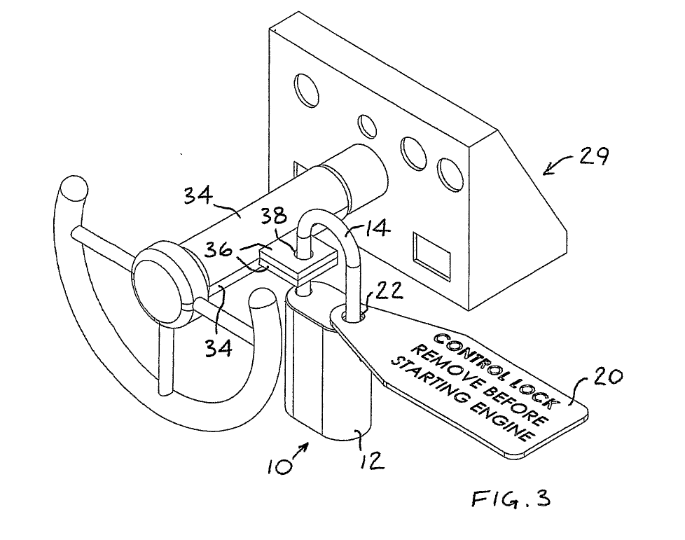

In FIG. 3, the aircraft locking system 10 is shown with shackle 14 passing through and locking sleeve locking elements 34. Sleeve locking elements 34 may be partial tubular elements that fit on to flight control system 28. Shackle 14 may pass through holes 38 formed in flanges 36 of sleeve locking elements 34.

In FIG. 4, the aircraft locking system 10 is shown locking a floor-mounted flight control system 40. The sleeve locking elements 34 may be formed with a hole 42 for the flight control system 40 to pass therethrough. In this example, shackle 14 may pass through and lock the sleeve locking elements 34, as in FIG. 3.

It will be appreciated by persons skilled in the art that the present invention is not limited by what has been particularly shown and described hereinabove. Rather the scope of the present invention includes both combinations and subcombinations of the features described hereinabove as well as modifications and variations thereof which would occur to a person of skill in the art upon reading the foregoing description and which are not in the prior art.

What is claimed is:

1. An aircraft locking system comprising:
an electromechanical lock comprising a shackle actuable by the lock, said shackle being adapted to lock a flight control system.

2. The aircraft locking system according to claim 1, wherein said electromechanical lock comprises data encryption electronics.

3. The aircraft locking system according to claim 1 or claim 2, further comprising a warning label having a mounting hole through which said shackle passes, said warning label having an indication formed thereon that warns that said shackle must be removed before performing a flight-related action.

4. The aircraft locking system according to any of claims 1-3, wherein said electromechanical lock comprises a padlock body.

5. The aircraft locking system according to any of claims 1-4, wherein said electromechanical lock comprises an anti-tampering electronic tag adapted to provide an output indication of an attempt to tamper with said aircraft locking system.

6. An aircraft comprising:
a flight control system; and
an electromechanical lock comprising a shackle actuable by the lock, said shackle being adapted to lock the flight control system.

7. The aircraft according to claim 6, wherein said electromechanical lock comprises data encryption electronics.

8. The aircraft according to claim 6 or claim 7, further comprising a warning label having a mounting hole through which said shackle passes, said warning label having an indication formed thereon that warns that said shackle must be removed before performing a flight-related action.

9. The aircraft according to any of claims 6-8, wherein said electromechanical lock comprises a padlock body.

10. The aircraft according to any of claims 6-9, wherein said electromechanical lock comprises an anti-tampering electronic tag adapted to provide an output indication of an attempt to tamper with said lock.

11. The aircraft according to any of claims 6-10, wherein said shackle passes through and locks a gust lock hole on said flight control system.

12. The aircraft according to any of claims 6-10, wherein said shackle passes through and locks a flexible locking member and a yoke member, at least one of said flexible locking member and said yoke member passing through a gust lock hole on said flight control system.

13. The aircraft according to any of claims 6-10, wherein said shackle passes through and locks sleeve locking elements that fit on the flight control system.

14. The aircraft according to claim 13, wherein said shackle passes through holes formed in flanges of said sleeve locking elements.

15. The aircraft locking system according to any of claims 1-5 and substantially as shown and described hereinabove.

16. The aircraft according to any of claims 6-14 and substantially as shown and described hereinabove.
